(19) United States
(12) Patent Application Publication
(10) Pub. No.: US 2026/0249631 A1
(43) Pub. Date: Aug. 27, 2026

(54) PRINTER CALIBRATION MECHANISM

(71) Applicants: Mikel Stanich, Boulder, CO (US); Walter F. Kailey, Boulder, CO (US)

(72) Inventors: Mikel Stanich, Boulder, CO (US); Walter F. Kailey, Boulder, CO (US)

(73) Assignee: Ricoh Company, Ltd., Tokyo (JP)

(21) Appl. No.: 19/064,005

(22) Filed: Feb. 26, 2025

(51) Int. Cl. B41J 29/393; B41J 2/045; G06K 15/02; G06K 15/10

(52) U.S. Cl. CPC B41J 29/393; B41J 2/0456; B41J 2/04586; G06K 15/102; G06K 15/1881

(57) ABSTRACT

A printing system is disclosed. The printing system includes at least one physical memory device to store calibration logic and one or more processors coupled with the at least one physical memory device to execute the calibration logic to generate a second printer transfer function to calibrate ink deposition of a print system for each of the plurality of color planes based on first ink deposition data, second ink deposition data and a first printer transfer function, wherein the first ink deposition data, the second ink deposition data and the first printer transfer function are associated with a common halftone design.

### FIELD OF THE INVENTION

The invention relates to the field of image reproduction, and in particular, to printer calibration.

### BACKGROUND

Entities with substantial printing demands typically implement a high-speed production printer for volume printing (e.g., one hundred pages per minute or more). Production printers may include continuous-forms printers that print on a web of print media (or paper) stored on a large roll. A production printer typically includes a localized print controller that controls the overall operation of the printing system, and a one or more print engines that includes one or more printhead assemblies, where each assembly includes a printhead controller and a printhead (or array of printheads). Each printhead contains many nozzles (e.g., inkjet nozzles) for the ejection of ink or any colorant suitable for printing on a medium.

### SUMMARY

In one embodiment, a printing system is disclosed. The printing system includes at least one physical memory device to store calibration logic and one or more processors coupled with the at least one physical memory device to execute the calibration logic to generate a second printer transfer function to calibrate ink deposition of a print system for each of the plurality of color planes based on first ink deposition data, second ink deposition data and a first printer transfer function, wherein the first ink deposition data, the second ink deposition data and the first printer transfer function are associated with a common halftone design.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIGS. 2A&2B are block diagrams illustrating embodiment of a print controller;

FIG. 3 illustrates one embodiment of a compensation module;

FIG. 4 illustrates one embodiment of ink deposition determination logic;

FIG. 5A illustrates one embodiment of halftoning via an MTA;

FIG. 5B illustrates one embodiment of a graph showing a distribution of drop fractions;

FIG. 6 is a flow diagram illustrating one embodiment of a process for generating ink deposition data;

FIG. 7 illustrates one embodiment of a calibration engine;

FIG. 8 illustrates one embodiment of printer calibration logic;

FIGS. 9A & 9B illustrate embodiments for generating a transfer function;

FIG. 10 is a flow diagram illustrating one embodiment of a process for generating printer transfer functions;

FIG. 11 is a flow diagram illustrating one embodiment of a process for generating printer halftones;

FIG. 12 illustrates one embodiment of a compensation module implemented in a network; and

FIG. 13 illustrates one embodiment of a computer system.

### DETAILED DESCRIPTION

Optical Density (OD) of production printers changes over time as components wear. For example, OD increases in an ink jet printer as drop sizes increase due to the wear of printhead components. This change in performance is undesirable because it impacts the consistency of color management. One approach to maintain consistency is to recalibrate primary colors to a specific target OD using a customer's paper.

Typically, the target OD is maintained by performing spectrophotometric measurements to determine a measured OD and performing a calibration process to maintain a constant OD to compensate for OD differences between the measured OD and the target OD. However, performing spectrophotometric measurements is a time-consuming process, which requires the generation, printing, and measurement of test charts.

According to embodiments, a printer calibration mechanism that implements measured drop size changes received from a printer is described. In the following description, for the purposes of explanation, numerous specific details are set forth to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

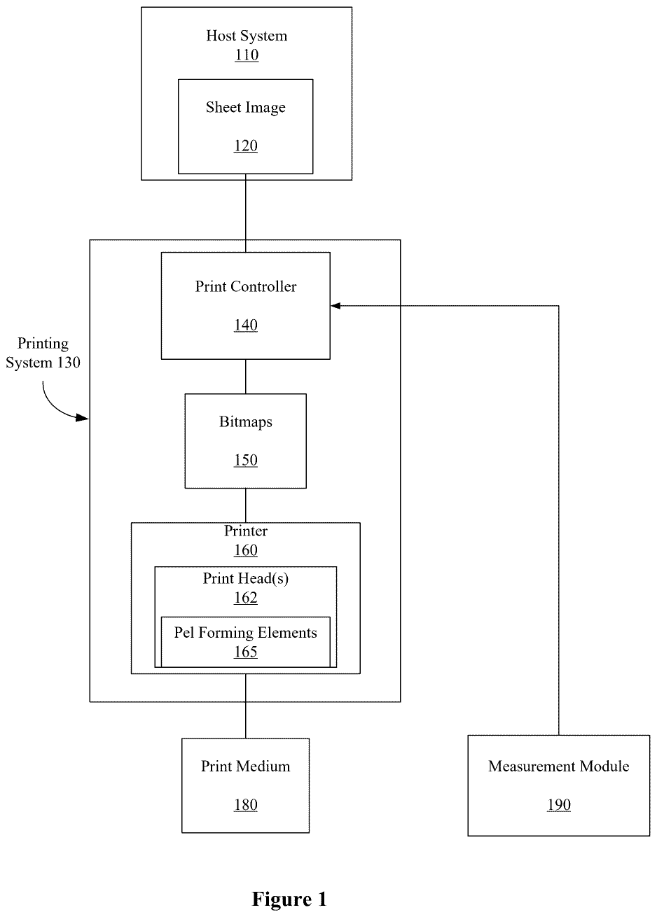

FIG. 1 is a block diagram illustrating one embodiment of a printing system 130. A host system 110 is in communication with the printing system 130 to print a sheet image 120 onto a print medium 180 via a printer 160 (e.g., print engine). Print medium 180 may include paper, card stock, paper board, corrugated fiberboard, film, plastic, synthetic, textile, glass, composite, or any other tangible medium (e.g., a print substrate) suitable for printing. The format of print medium 180 may be continuous form or cut sheet or any other format suitable for printing. Printer 160 may be an ink jet, electrophotographic or another suitable printer type.

In one embodiment, printer 160 comprises one or more printheads 162, each including one or more pel forming elements 165 that directly or indirectly (e.g., by transfer of marking material through an intermediary) forms the representation of picture elements (pels) on the print medium 180 with marking material applied to the print medium. In an ink jet printer, the pel forming element 165 is a tangible device that ejects the ink onto the print medium 180 (e.g., an ink jet nozzle) and, in an electro-photographic (EP) printer the pel forming element may be a tangible device that determines the location of toner particles printed on the print medium (e.g., an EP exposure LED or an EP exposure laser). The pel forming elements may be grouped onto one or more printheads 162. The pel forming elements 165 may be stationary (e.g., as part of a stationary printhead 162) or moving (e.g., as part of a printhead 162 that moves across the print medium 180) as a matter of design choice. The pel forming elements 165 may be assigned to one or more color planes that correspond to types of marking materials (e.g., Cyan, Magenta, Yellow, and Black (CMYK)).

In a further embodiment, printer 160 is a multi-pass printer (e.g., dual pass, 3 pass, 4 pass, etc.) wherein multiple sets of pel forming elements 165 print the same region of the print image on the print medium 180. The set of pel forming elements 165 may be located on the same physical structure (e.g., an array of nozzles on an ink jet print head 162) or separate physical structures. The resulting print medium 180 may be printed in color and/or in any of a number of gray shades, including black and white (e.g., Cyan, Magenta, Yellow, and Black, (CMYK)). The host system 110 may include any computing device, such as a personal computer, a server, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, and/or any other printer language data. The print controller 140 processes the sheet image to generate a bitmap 150 for transmission. The bitmap 150 includes the instructions (e.g., instructed ink drop size and/or instructed pel forming element location) for the one or more printheads 162 and pel forming elements 165. Bitmap 150 may be a halftoned bitmap (e.g., a compensated halftone bit map generated from compensated halftones, or uncompensated halftone bit map generated from uncompensated halftones) for printing to the print medium 180. The printing system 130 may be a high-speed printer operable to print relatively high volumes (e.g., greater than 100 pages per minute).

The print medium 180 may be continuous form paper, cut sheet paper, and/or any other tangible medium suitable for printing. The printing system 130, in one generalized form, includes the printer 160 that presents the bitmap 150 onto the print medium 180 (e.g., via toner, ink, etc.) based on the sheet image 120. Although shown as a component of printing system 130, other embodiments may feature printer 160 as an independent device communicably coupled to print controller 140.

The print controller 140 may be any system, device, software, circuitry, and/or other suitable component operable to transform the sheet image 120 for generating the bitmap 150 in accordance with printing onto the print medium 180. In this regard, the print controller 140 may include processing and data storage capabilities. In one embodiment, measurement module 190 is implemented as part of a compensation system to obtain measurement data from printing system 130. The measured results are communicated to print controller 140 to be used in a compensation process. The measurement system may be a stand-alone process or be integrated into the printing system 130.

According to one embodiment, measurement module 190 may comprise one or more sensors to take measurements of an output response for printing system 130. Measurement module 190 may generate and transmit measurement data to obtain the output response of printing system 130. In a further embodiment, measurement data may comprise ink drop size data. In one embodiment, measurement module 190 may comprise one or more sensors that each or in total take measurements of real time drop sizes for some or all pel forming elements 165.

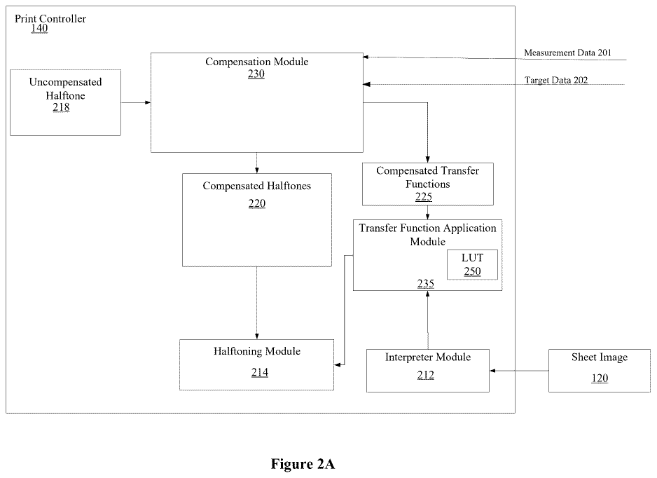

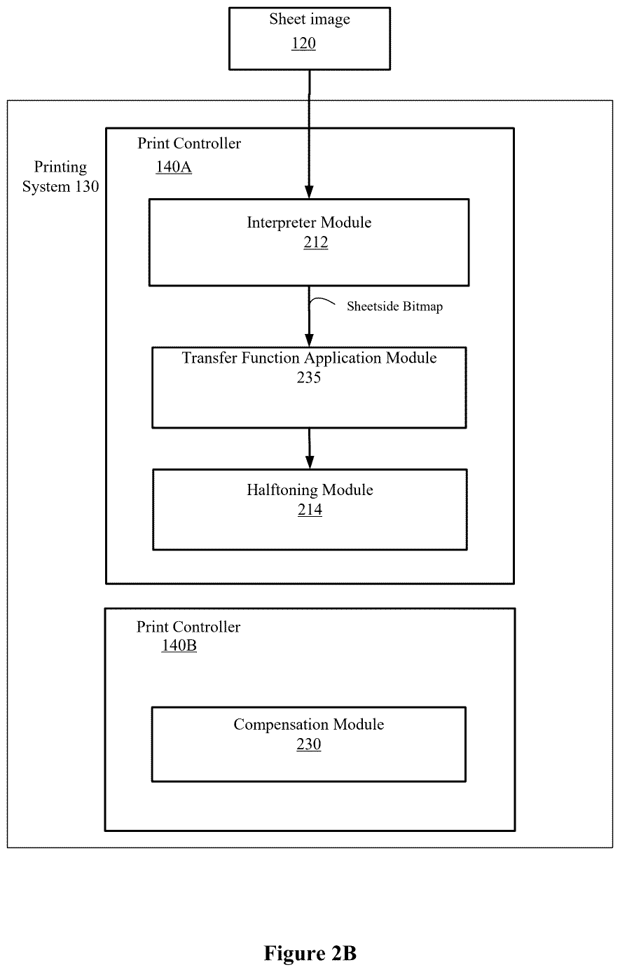

FIG. 2A illustrates a print controller 140 (e.g., DFE or digital front end), in its generalized form, including interpreter module 212, halftoning module 214 and compensation module 230. These separate components may represent hardware used to implement the print controller 140. Alternatively, or additionally, the separate components may represent logical blocks implemented by executing software instructions in a processor of the printer controller 140. FIG. 2B illustrates an alternative embodiment having print controllers 140A&140B. In this embodiment, print controller 140A includes interpreter module 212 and halftoning module 214, and print controller 140B includes compensation module 230. Print controllers 140A and 140B may be implemented in the same printing system 130 (as shown) or may be implemented separately.

The interpreter module 212 is operable to interpret, render, rasterize, or otherwise convert images (e.g., raw sheetside images such as sheet image 120) of a print job into sheetside bitmaps. The sheetside bitmaps generated by the interpreter module 212 for each primary color are each a 2-dimensional array of pels representing an image of the print job (e.g., a Continuous Tone Image or CTI), also referred to as full sheetside bitmaps. The 2-dimensional pel arrays are considered “full” sheetside bitmaps because the bitmaps include the entire set of pels for the image. The interpreter module 212 is operable to interpret or render multiple raw sheetsides concurrently so that the rate of rendering substantially matches the rate of imaging of production print engines. In one embodiment, transfer functions may be implemented by print controller 140 and applied directly to image data as a part of the image processing prior to printing. In that case, the contone image data (e.g., CTI data) is transformed by applying the transfer functions to the CTI data prior to halftoning. A transfer function comprises a mapping of an input digital count to an output digital count for a system, where digital count (DC) is the gray level or color value representing the pels in a bitmap 150 (FIG. 1). Transfer functions may be used for calibrating printing system 130 with a resulting technical benefit of providing a compact form with reduced computational requirements.

Halftoning module 214 is operable to represent the sheetside bitmaps as halftone patterns of ink. For example, halftoning module 214 may convert the pels (also known as pixels) to halftone patterns of CMYK ink for application to the paper. A halftone design may comprise a pre-defined mapping of input pel gray levels to output drop sizes (e.g., instructed ink drop sizes transmitted to printheads) based on pel location.

In one embodiment, the halftone design may include a finite set of transition thresholds between a finite collection of successively larger drop sizes, beginning with zero and ending with a maximum drop size (e.g., zero, small, medium, and/or large). The halftone design may be implemented as threshold arrays (e.g., halftone threshold arrays) such as single bit threshold arrays or multibit threshold arrays. In another embodiment, the halftone design may be implemented as a three-dimensional look-up table with all included gray level values.

In a further embodiment, halftoning module 214 performs the multi-bit halftoning using the halftone design including a set of threshold values for each pel in the sheetside bitmap, where there is one threshold for each non-zero ink drop size. The pel is halftoned with the drop size corresponding to threshold values for that pel. The set of thresholds for a halftone design is referred to as a multi-bit threshold array (MTA).

Multi-bit halftoning is a halftone screening operation in which the final result is a selection of a specific drop size available from an entire set of drop sizes that the print engine is capable of employing for printing. Drop size selection based on the contone value of a single pel is referred to as “Point Operation” halftoning. The drop size selection is based on the contone levels for each pel in the sheetside bitmap. This contrasts with “Neighborhood Operation” halftoning, where multiple pels in the vicinity of the pel being printed are used to determine the drop size. Examples of neighborhood operation halftoning include the well-known error diffusion method.

Multi-bit halftoning is an extension of binary halftoning, where binary halftoning may use a single threshold array combined with a logical operation to decide if a drop is printed based on the contone level for a pel. Binary halftoning uses one non-zero drop size plus a zero drop size (e.g., a drop size of none where no ink is ejected). Multi-bit halftoning extends the binary threshold array concept to more than one non-zero drop size.

Multi-bit halftoning may use multiple threshold arrays (e.g., multi-bit threshold arrays), one threshold array for each non-zero drop size. The point operation logic is also extended to a set of greater than, less than or equal to operations to determine the drop size by comparing the threshold or thresholds with image contone data for each pel. Multi-bit defines a power of two set of drop sizes (e.g., two-bit halftone designs have four total drops, including a zero drop size). While power of two may be employed to define the number of drops, systems not following this such as a three total drop system may be used and are still considered multi-bit.

For multi-bit halftones, the MTA is a three-dimensional array including one two-dimensional array for each drop size (e.g., instructed ink drop size) transition. Thus, an MTA includes a set of two-dimensional arrays of thresholds for transition between drop sizes: a first plane (or plane 1) provides the threshold for the Large output level, while a second plane (or plane 2) and third plane (or plane 3) provide thresholds for the Medium and Small output levels respectively for a system having three drop sizes, not including zero drop size (none or Off). In other embodiments, different one-to-one relationship may be used since the correspondence between plane numbers and drop sizes is a matter of design choice.

To use these threshold arrays for halftoning, each multibit threshold array is tiled across the contone image data provided by the sheetside bitmap, which provides a set of threshold values for each pixel in the sheetside bit map. The contone image data (e.g., digital count, gray level data) is logically compared to the threshold data on a pixel basis. In the case of Large drops, they are produced by the halftoning when the image contone data is greater than the respective large threshold values in plane 1.

Medium drops are produced when the image contone data is greater than the medium drop plane 2 thresholds and the image contone data is less than or equal to the large drop thresholds in plane 1. Small drops are produced when the image contone data is greater than the small drop thresholds in plane 3 and the image contone data is less than or equal to the medium drop thresholds in plane 2.

Finally, the off/none drop size occurs for cases when the contone image data is less than or equal to the small drop thresholds in plane 3. In this embodiment of a two-bit multibit printing system, this set of four logical equations, used with thresholds from each plane of the multibit threshold array permit each printing drop size to be defined based on the contone values.

Alternate versions of the halftoning equations may also be defined. An example of an alternate set of halftoning logical expressions replaces the less than or equal to operation with less than and the greater than operation is replaced with greater than or equal too. A further variation uses the less than or equal to and greater than logical expressions starting with the test for the largest drop size first. If a drop size is not found the process continues with the logical expression for the next smallest drop size. If the sequential test for each drop size does not find a drop size, the none drop size is assumed. The threshold arrays for each different set of halftoning equations will vary and therefore the threshold arrays are generated assuming a given set of equations.

In other embodiments, the number of planes of threshold data can be extended to handle any number of drop sizes. The data of these two-dimensional arrays may be segmented into separate memory regions and stored in any convenient order. For example, the thresholds for each drop size transition may be stored contiguously in memory, and it is often advantageous to do so.

Compensation module 230 performs a compensation process on an un-compensated halftone 218, or previously generated uniformity compensated halftone, received at print controller 140 to generate one or more compensated halftones 220. Compensation module 230 may be used to generate compensated halftones 220 for each color plane of print system 130 based on input data from the corresponding color plane. A compensated halftone comprises a halftone that has been adjusted to achieve a target output response. Compensated halftones 220 are then received at halftoning module 214 along with the sheetside bitmap.

In one embodiment, an un-compensated halftone 218 represents a reference halftone design that is modified to create the compensated halftones based on measurement data 201 and target data 202. In such an embodiment, measurements of the system response (e.g., measurement data 201) are received as drop size data via measurement module 190 using the un-compensated halftone 218.

Compensation module 230 may alternatively perform a compensation process to generate compensated transfer functions 225 based on measurement data 201 and target data 202. Compensation module 230 may be used to generate compensated transfer functions 225 for each print system 130 color based on input data from the corresponding color plane. The measurement units for measurement data 201 directly or through additional processing have the same measurement units as target data 202. Compensated transfer functions 225 are then received at transfer function application module 235. Transfer function application module 235 applies the received compensation transfer functions 225 to print image data received from interpreter module 212 prior to performing halftoning at halftoning module 214. In one embodiment, a transfer function is a lookup table 250 that comprises the mapping of an input digital count (or tint) to an output digital count for a system. Transfer functions may be received or generated (e.g., generated based on target ink drop size or OD versus input digital count data and measured ink drop size or OD versus output digital count data).

According to one embodiment, a compensated transfer function comprises a printer transfer function (e.g., printerTF), which is a mapping of an input digital count to an output digital count for a print system to achieve a first target response (e.g., a target ink deposition, or a target OD) while printing on a first print substrate (e.g., S1 or a reference print substrate) with a first halftone design (e.g., a common halftone design or a reference halftone design). When the printer transfer function is applied to the print system, the print system becomes a calibrated print system.

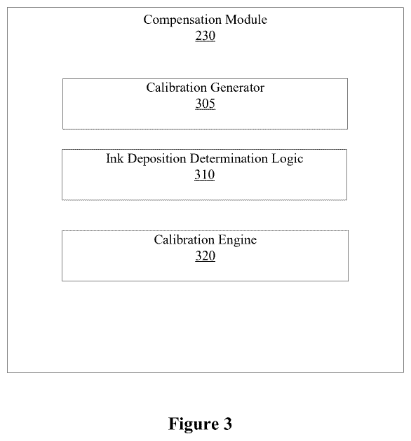

FIG. 3 illustrates one embodiment of compensation module 230 implemented to generate calibration data based on ink drop size data. According to one embodiment, compensation module 230 generates the calibration data as transfer functions. In such an embodiment, compensation module 230 generates an updated (or second) transfer function to calibrate ink deposition of a print system for each of the plurality of color planes based on first ink deposition data, second ink deposition data, and a current (or first) printer transfer function, wherein the first ink deposition data, the second ink deposition data and the current printer transfer function are associated with a common (or first) halftone design. A resulting technical benefit is efficiently calibrating a print system without needing knowledge about the halftone design.

In an alternative embodiment, compensation module 230 generates the calibration data as halftones. In this embodiment, compensation module 230 generates an updated (or second) halftone design to calibrate ink deposition of a print system for each of the plurality of color planes based on first ink deposition data, second ink deposition data, a printer transfer function and a current (or first) halftone design, wherein the first ink deposition data, the second ink deposition data and the printer transfer function are associated with the current halftone design. A resulting technical benefit is efficiently calibrating a print system.

As shown in FIG. 3, compensation module 230 includes a calibration generator 305, ink deposition determination logic 310 and calibration engine 320. Calibration generator 305 facilitates a calibration process at print system 130 by directing the calibration process. In one embodiment, the calibration process is performed to generate or update the print system (or printer) transfer function (e.g., for long term printer OD change compensation). In such an embodiment, each calibration is based on a calibration performed using a print substrate (e.g., print medium or customer paper) to be implemented to print jobs at printing system 130. In a further embodiment, each calibration may be initiated by a system operator through a user interface in printing system 130.

Ink deposition data may be received or generated by compensation module 230. Ink deposition determination logic 310 generates ink deposition data based on received ink drop size data upon initiation of a calibration process at calibration generator 305. In one embodiment, first ink deposition data associated with a halftone design (e.g., a common halftone design) is generated during a first calibration process based on a first set of ink drop size data and ink drop fraction data (e.g., common ink drop fraction data). In one embodiment the first ink deposition data is generated using an initial transfer function that may be an identity transfer function (or equivalent whereby no compensation is applied to the image data). Similarly, second ink deposition data associated with the halftone design (e.g., the common halftone design) is generated during a subsequent calibration process based on a second set of ink drop size data and the ink drop fraction data (e.g., common ink drop fraction data). Ink deposition functions may be generated for each of a plurality of color planes in printing system 130. A resulting technical benefit for generating and applying ink deposition functions is their compatibility with ink models, and compact form with reduced computational requirements.

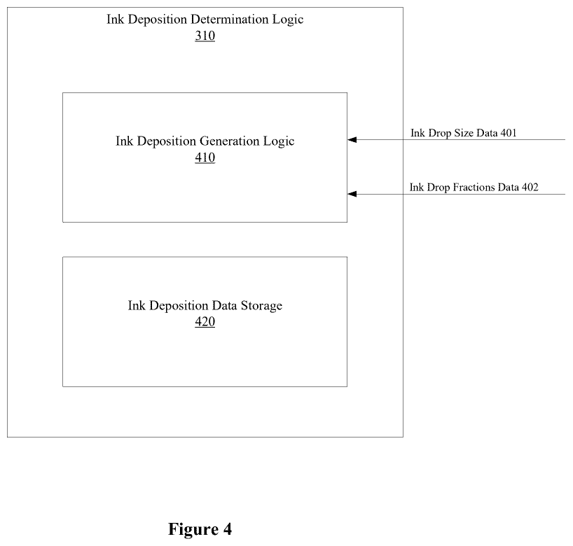

FIG. 4 illustrates one embodiment of ink deposition determination logic 310. As shown in FIG. 4, ink deposition determination logic 310 includes ink deposition generation logic 410 that generates ink deposition data based on ink drop size data 401 and ink drop fractions data 402 where ink drop fractions data 402 corresponds to the printer halftone design (e.g., the common halftone design). In one embodiment, ink drop size data 401 comprises (or is derived from) measurement data 201 and represents quantitative ink drop amounts corresponding to each instructed ink drop size. Additionally, ink drop size data may comprise a volume or a mass expressed in quantities of standardized units (e.g., metric system units such as grams or liters).

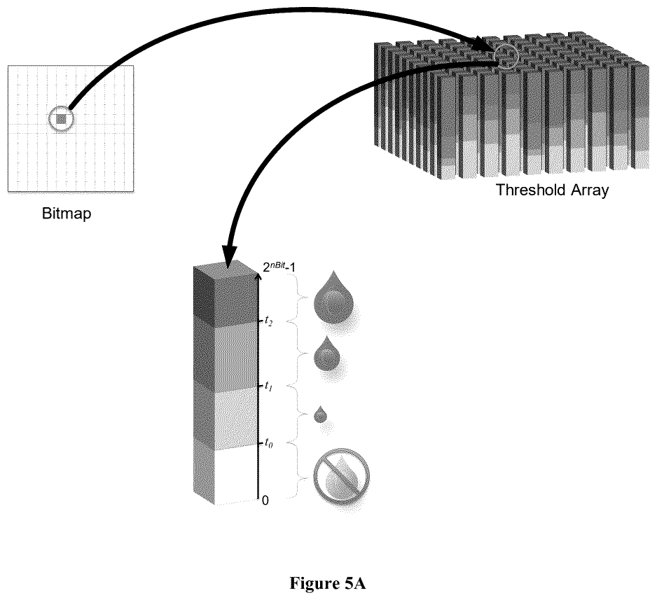

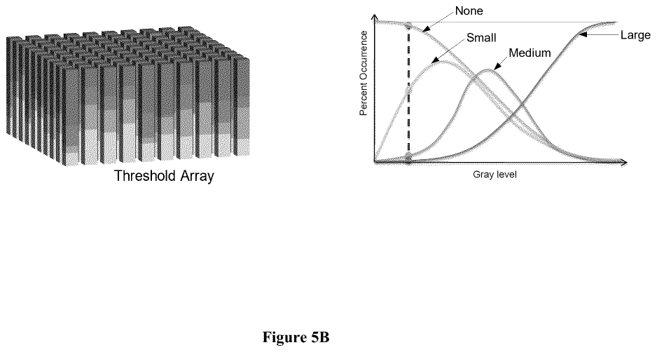

Ink drop fractions indicate an occurrence rate of drops for each drop size at each gray level based on a halftone threshold array, such that a total number of drops of a specific drop size X at DC=dropFraction_X(DC)*total number of pels in a halftone array. Ink drop fractions may be expressed as fractions, percentages or other suitable representations and organized into matrices. FIG. 5A illustrates another embodiment of halftoning via an MTA that consists of determining which “bin” a particular pixel is to be included, and subsequently selecting the corresponding instructed drop size based on the pixel value (e.g., gray level) and the thresholds of the bin. In this embodiment, the logical comparison operations described previously are depicted by individual “totem poles” for each corresponding pixel of image data. Drop size determination is performed by finding which bin the threshold levels index for each pixel value. It should be appreciated from FIG. 5A that each totem pole may have different bin ranges for each different drop size. Furthermore, the bin determination depends on the specific halftoning equations employed. A resulting technical benefit for applying ink drop fractions is their compact form with reduced computational requirements.

In a further embodiment, definition of the mapping ranges for each drop size bin are defined by the threshold values t0, t1, t2, which are specific values for that pixel location from the multibit threshold array. As shown in FIG. 5A, each pixel in the bitmap selects a specific corresponding totem pole. The gray level for that pixel in the bitmap is then mapped to a particular bin, and a drop size I (e.g., 0-2^{nBit}−1) is selected. The maximum height of the totem poles is related to the bit depth of the contone data. In a typical 8-bit printing system, nBit equals 8. Therefore, in that case the top of the totem pole corresponds to level 255 (2⁸−1), which is the largest digital count value permitted for this 8-bit printing system. A threshold value referred to as a placeholder threshold is supported such that the printing of a drop size is inhibited. When the placeholder threshold is used, the set of logical halftoning equations is not satisfied when the contone level is equal to the maximum contone level resulting in the drop size associated with that threshold not ever being printed. A threshold equal to the placeholder threshold may be employed for one or more of the drop sizes. The use of placeholder thresholds limits the drop fractions as a result of restriction of drops from printing. A practical result of this limitation with the placeholder thresholds is that the maximum drop fraction for all drop sizes may be less than one or 100%. FIG. 5B illustrates one embodiment of a graph showing a distribution of drop fractions (the vertical axis) for gray levels (the horizontal axis) for a multi-bit threshold array for all drops sizes (e.g., each of 4 drop sizes including the none drop).

In one embodiment, ink deposition generation logic 410 generates ink deposition data during each calibration process and stores the data in ink deposition data storage 420. In such an embodiment, ink deposition data may be represented as an average ink volume or mass per pel, where pels can also be noted as surface area. Thus, average ink deposition can be expressed as the matrix multiplication of a drop fraction matrix and drop size vector. In a further embodiment, ink deposition data (e.g., ID1, a first ink deposition data) generated during a first calibration process may be represented as (ID1(DC)=[Z⁰v⁰]), where Z⁰ comprises an ink drop fractions matrix (e.g., ink drop fractions data) for a current halftone threshold array (e.g., TA1 or a first halftone threshold array) and v⁰ comprises an initial ink drop size vector or matrix (e.g., a first ink drop size data), as represented by:

$${Z}^{0} = [ \begin{matrix}{z}_{0 , 0}^{0} & ⋯ & {z}_{0 , D - 1}^{0} \\ ⋱ & ⋰ & ⋱ \\ {z}_{P - 1 , 0}^{0} & ⋯ & {z}_{P - 1 , D - 1}^{0}\end{matrix} ] ; and {v}^{0} = [ \begin{matrix}{v}_{0}^{0} \\ ⋰ \\ {v}_{D - 1}^{0}\end{matrix} ] ,$$

As shown above, the initial ink drop fractions matrix Z⁰ comprises a set of Z⁰_{p,d} matrix elements, each element corresponding to a digital count level based on row index (p) and instructed ink drop size based on column (d). In one embodiment, each row (p) of elements in ink drop fractions matrix Z⁰ is associated with a different digital count level (DCₚ) and each column of elements is associated with a different instructed drop size d. Ink drop fractions are defined as the fraction of drops in the halftone threshold array (maximum domain=[0,1]) for a given drop size (v⁰_{d}) in the drop size column vector and the associated digital count (DCₚ). Ink drop fractions are determined for each drop size and vary from zero to a maximum value of one, where one indicates for a given DC level that the halftoned result for every pel in the halftone threshold array will be the given drop size. Ink drop fractions define the degree to which the different drop sizes (e.g., v⁰_{d}) of the halftone design are output at each DCₚ level. The resulting ID1 vector has P total elements, each having an associated digital count value DCₚ. The ID1 ink deposition function is defined as a function of DC level. In such an embodiment, digital count (e.g., [0,(2\hat{ }bitdepth)−1]) is the gray level or color value of the input pixels. Bitdepth defines the number of available digital count levels as a power of two. In the previously cited example, the bitdepth is 8, producing 256 levels of digital count. In such an embodiment, ink drop fractions data (e.g., drop fraction) data represents the number of drops for a specific instructed drop size at a given DC level divided by the total number of drops possible for a halftone design. Ink drop fractions data may be received or generated. Ink drop fractions data may be generated by ink drop measurements or by applying a synthetic image job to the halftone design and analysis of the output response. Presuming a constant tint level (e.g., a constant digital count for all halftoned pels) synthetic images are applied to the halftone design to determine the ink drop fractions data for each row p of the drop fraction matrix Z⁰. Where the DC level for each row p is the DC level employed in the synthetic image used to determine the drop fraction for that row.

Index p ranges from zero to P-1,where P is the total number of digital count levels. Index d ranges from zero to D-1, where D is the total number of instructed ink drop sizes, not including the ink drop size none. The ink drop size column vector v⁰ comprises ink amount values (e.g., v⁰₀ to v⁰_{D-1}) associated with each of the plurality of instructed ink drop sizes in the initial drop size column vector. In a further embodiment, the drop amounts v⁰₀ to v⁰_{D-1} are known (e.g., pre-determined). There is a one to one correspondence between the drop size vector elements and the columns in the Z⁰ drop size matrix (e.g., v⁰₀ drop size element 1 corresponds to the first column in the drop fraction matrix Z⁰).

Ink deposition data generated during a second calibration process (e.g., ID2) may be represented as (ID2(DC)=[Z⁰v¹]), where v¹ comprises a subsequent ink drop size vector (e.g., a second ink drop size data) after a drop size change has occurred, as represented by:

$${Z}^{0} = [ \begin{matrix}{z}_{0 , 0}^{0} & ⋯ & {z}_{0 , D - 1}^{0} \\ ⋱ & ⋰ & ⋱ \\ {z}_{P - 1 , 0}^{0} & ⋯ & {z}_{P - 1 , D - 1}^{0}\end{matrix} ] ; and {v}^{1} = [ \begin{matrix}{v}_{0}^{1} \\ ⋰ \\ {v}_{D - 1}^{1}\end{matrix} ] ,$$

Similar to above, the drop amounts v¹₀ to v¹_{D-1} are known. In one embodiment, Z⁰v⁰ and Z⁰v¹ are each column vectors that provide average ink depositions for digital count (DC) levels associated with each row p.

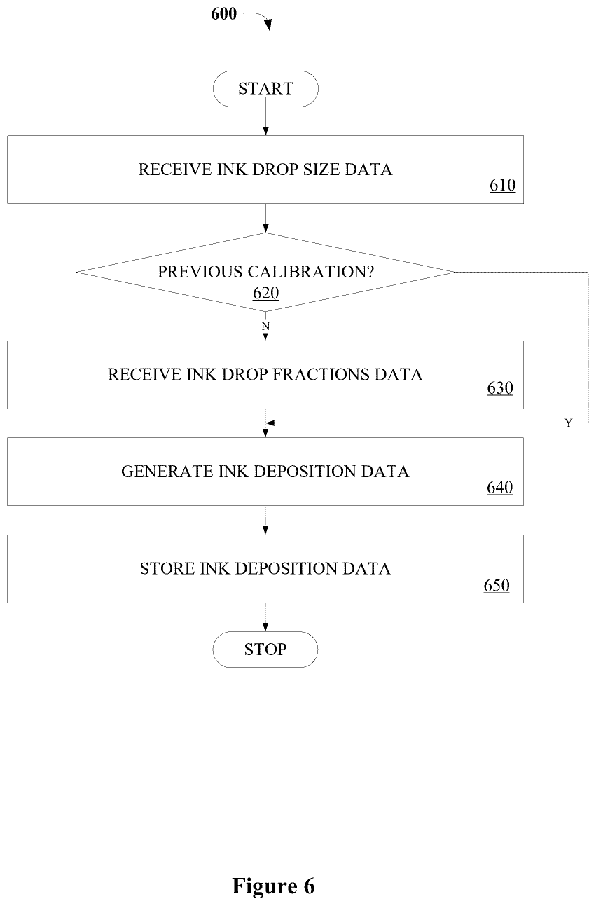

FIG. 6 is a flow diagram illustrating one embodiment of a process 600 for generating ink deposition data. Process 600 may be performed by processing logic that may include hardware (e.g., circuitry, dedicated logic, programmable logic, microcode, etc.), software such as instructions run on a processing device, or a combination thereof. In one embodiment, process 600 is performed by ink deposition generation logic 410.

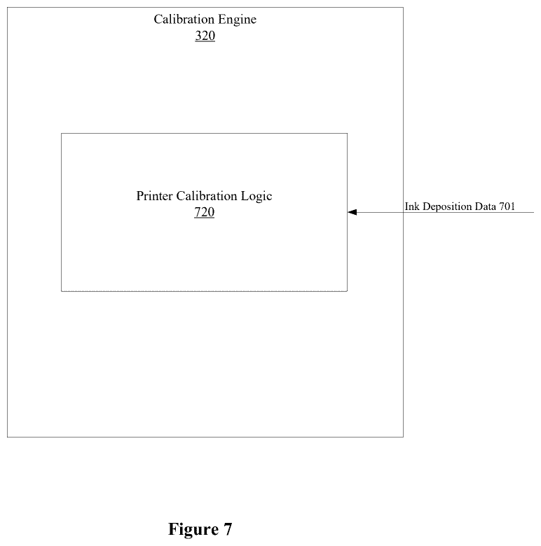

Process 600 begins at processing block 610, where ink drop size data 401 is received (e.g., from measurement module 190). At decision block 620, a determination is made as to whether a previous calibration has occurred (e.g., by reviewing metadata in the drop size data). If not, ink drop fractions data 402 is received at processing block 630. At processing block 640, ink deposition data is generated based on the ink drop size data 401 and the ink drop fractions data 402. At processing block 650, the ink deposition data is stored (e.g., at ink deposition data storage 420). Process 600 proceeds directly to processing block 640 upon a determination at decision block 620 that a previous calibration has occurred since the ink drop fractions data 402 will have already been received. Process 600 may be repeated with input data corresponding to each color plane of printing system 130 to generate corresponding ink deposition data. Referring back to FIG. 3, calibration engine 320 generates calibration data based on ink deposition data generated at ink deposition determination logic 310. FIG. 7 illustrates one embodiment of calibration engine 320 including printer calibration logic 720 that receives ink deposition data 701. In one embodiment, ink deposition data 701 comprises first ink deposition data (e.g., ID1) from a previous calibration process and second ink deposition data (e.g., ID2) from a current calibration process.

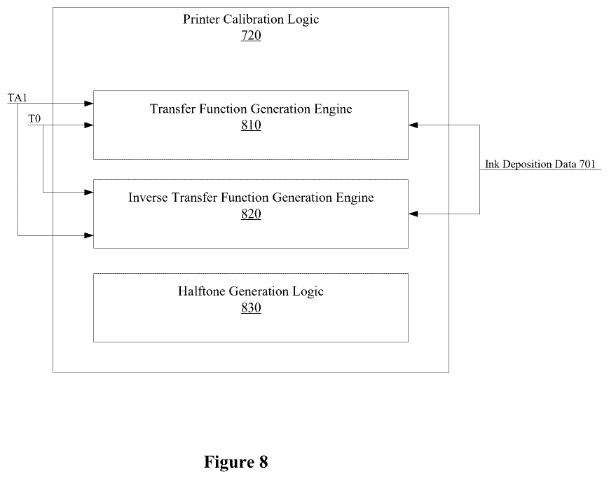

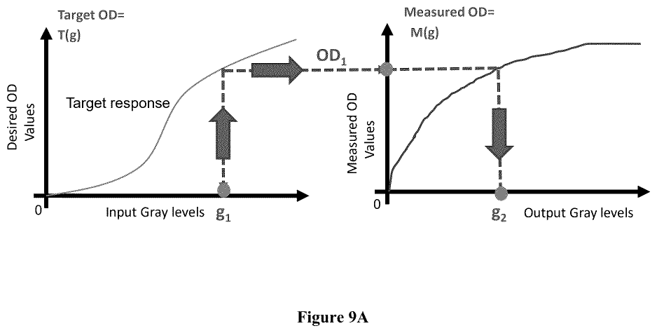

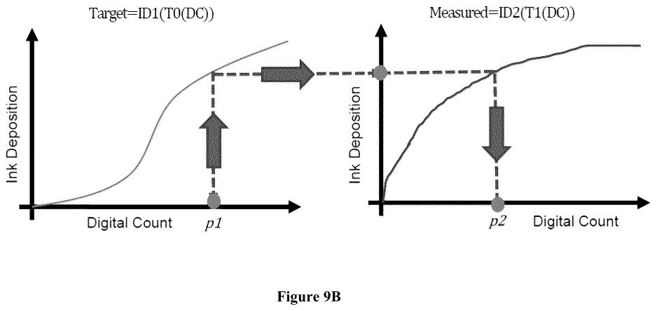

FIG. 8 illustrates one embodiment of printer calibration logic 720. As shown in FIG. 8, printer calibration logic 720 includes transfer function generation engine 810 that is used to perform compensation by generating a calibrated transfer function for each color plane based on ink deposition data 701. FIG. 9A illustrates one embodiment for generating a transfer function (e.g., a printer transfer function) for all digital count levels (e.g., gray levels). Target OD data T(g) (e.g., target OD data) is used as the objective for an applied current halftone design with an identity transfer function. The measured response is given by M(g) (e.g., measurement OD data). The measured response is determined by printing a single color corresponding to the ink using the entire range of gray levels or a subset of gray levels, which span the range of gray levels. Given the known response, at gray level g₁ the target OD is OD₁. To achieve OD_{1.}, print level g₂ is instructed to be printed. Using, for example, with the domain 0:255 for g₁, the set of g₂ values defines the transfer function. The transfer function represented as a continuous function defines: g_output=TF(g_input). The expression for the transfer function can be written in terms of the target T and inverse measured response M⁻¹, such that:

$$g\_output = {M}^{- 1} ( T ( g\_input ) ) = TF ( g\_input )$$

Using g_output values as replacement values for the corresponding g_input values, the calibrated target response is achieved for all levels. The transfer functions may be generated as a lookup table 250 or a mathematical curve. The transfer function curve may be generated though mathematical curve fitting (e.g., using cubic spline, smoothing spline curve or other known mathematical approximation techniques). Transfer function curves may then be evaluated with input values to determine output values by direct computation.

It is known from printer ink models that maintaining a constant ink deposition also achieves a constant OD. Accordingly, transfer functions may be generated to maintain ink deposition at a constant level (e.g., to maintain a level of ID2 with an updated transfer function applied that is the equivalent level to ID1 with an initial transfer function applied). FIG. 9B illustrates one embodiment for generating an updated printer transfer function T1 for all digital count levels (e.g., gray levels). ID1 and ID2 are ink deposition functions which are a function of DC values used with the applied transfer functions.

Target ink deposition function ID1(T0(DC)), shown on the left of FIG. 9B, is used as the objective for an applied current halftone design and T0(DC) as the applied current printer transfer function, where ID1 is obtained using the current set of drop sizes. The measured response is the ink deposition as a function of DC given by ID2(T1(DC)), as shown on the right of FIG. 9B, where ID2 is obtained using the updated set of drop sizes and T1 is an updated transfer function to obtain the same ink deposition that was achieved with the initial transfer function and drop sizes. Thus, the ink deposition data (e.g., ID1, ID2), printer transfer functions (e.g., T0, T1), ink drop sizes (e.g., ink drop size data 401), ink drop fractions (e.g., ink drop fractions data 402) are associated with (e.g., corresponds to) the printer halftone design (e.g., the common halftone design).

The updated transfer function is to be used to replace the initial transfer function to compensate for the changes in drop sizes which have occurred. Using the updated transfer function achieves the same OD target that was used with the original calibration of the initial printer transfer function using the initial drop sizes. Given the known response, at gray level p₁ the target ink deposition is indicated on the vertical axis of the measured response. To achieve the target ink deposition, print level p₂ is instructed to be printed. Using, for example, with the domain 0:255 for p₁, the set of p₂ values defines the updated transfer function.

The updated transfer function represented as a continuous function defines: p_output=T1(p_input). Using p_output values as replacement values for the corresponding p_input values, the calibrated target response is achieved for all levels. The transfer functions may be generated as a lookup table 250 or a mathematical curve. The transfer function curve may be generated though mathematical curve fitting (e.g., using cubic spline, smoothing spline curve or other known mathematical approximation techniques). Transfer function curves may then be evaluated with input values to determine output values by direct computation.

According to one embodiment, an updated printer transfer function T1(DC) may be generated based on ID1(T0(DC))=ID2(T1(DC)), such that T1(DC)=ID2⁻¹(ID1(T0(DC)), where T0(DC) comprises a current printer transfer function (e.g., a first printer transfer function) and T1(DC) comprises an updated printer transfer function (e.g., a second printer transfer function). In such an embodiment, T1 achieves the initial ink volume per pel which was obtained with drop size set v0 using the new drop size set v1. Thus, T1 is a printer transfer function that replaces T0 (the prior printer TF) to compensate for changes to drop sizes (e.g., drop size drift). T0 would be used in the printer system for initial production printing. After the drop size change occurs from v0 to v1, the new transfer function T1 would be employed as a replacement for T0. Similarly, a printer transfer function T1 may be generated for each color plane of printing system 130 based on input data corresponding to the color plane.

A further embodiment employs a composite transfer function instead of a printer transfer function to print with different customer substrates. The transfer function for the customer substrate paper is substrateTF(DC). The substrate transfer function is derived using the previously described OD calibration process for a variety of different papers and/or OD targets. In such a system, the printer transfer function T2 is used instead of T1. Where T2 is equal to the composite transfer function (e.g., T2(DC)=T0(substrateTF(DC))) assuming the original drop size set v0. After the drop size change occurs to a new drop size set v1 a new T2 function is defined in terms of T1 (e.g., T2(DC)=T1(substrateTF(DC))). T2 is also associated with the halftone design (e.g., the common halftone design).

Using the approach previously described, an updated T1 transfer function is derived to compensate for the change to the new drop size set v1 (e.g., T1(DC)=ID2⁻¹(ID1(T0(DC))). The updated T1 printer transfer function is then used to form the composite transfer function. Since the updated printer transfer function T1 achieves the same ink deposition as T0, the composite transfer function updated to use T1 (e.g., T1(substrateTF(DC))) will also have the same ink deposition as the original composite function which provides compensation for drop size changes in a composite TF printer system employing different substrate transfer functions. The final transfer function that print system 130 may apply is created by a composite transfer function. The final composite transfer function used for printing may be written as follows:

$$FinalTF ( D C ) = T 1 ( substrateTF ( D C ) ) = T 1 ∘ substrateTF ( D C )$$

FinalTF(DC) is a mathematical composition of the two transfer functions. The composition f∘g of two functions f and g is the function formed by first applying the function g and then the function f. In other words, to apply the composition f∘g to an input x, perform the following two steps. First apply the function g to the input x and obtain the result g(x) as the output. Next, apply the function f using g(x) as the input and obtain the result f(g(x)) as the output. The composition may be written as (f∘g) (x)=f(g(x)) where the “∘” symbol represent the mathematical composition function.

In one embodiment the drop fraction matrices can be expressed as tabular functions using discrete sets of values where the matrices provide drop fractions for a sparse set of values that does not include all DC levels. The solutions in this case may account for the conversion to DC levels that are required for the transfer functions to estimate the continuous functions. Interpolation may be used to generate intermediate values. Furthermore, transfer function values can be scaled to provide a match to the domains and ranges of the printer system. This may be used to convert 8 bit contone image levels to 14 bit halftone threshold levels. The specific halftoning equations used may be accounted for in this scaling process.

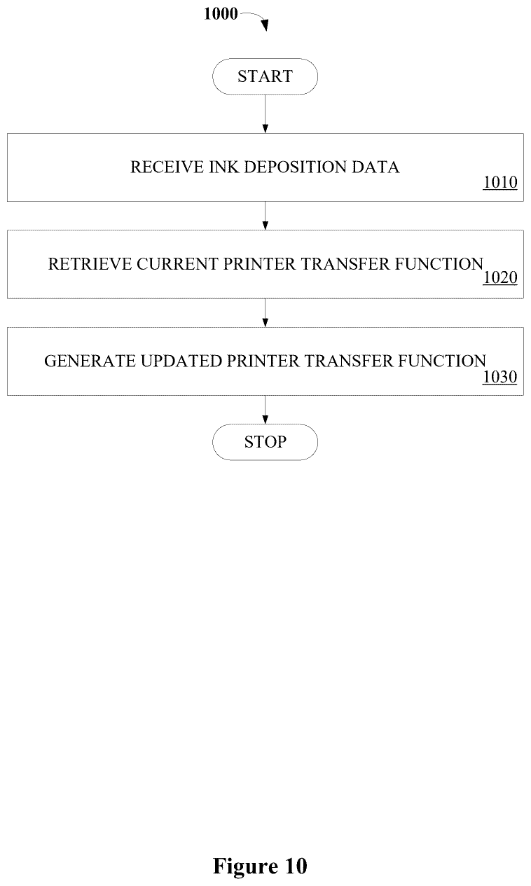

FIG. 10 is a flow diagram illustrating one embodiment of a process 1000 for generating updated printer transfer functions. Process 1000 may be performed by processing logic that may include hardware (e.g., circuitry, dedicated logic, programmable logic, microcode, etc.), software such as instructions run on a processing device, or a combination thereof. In one embodiment, process 1000 is performed by printer calibration logic 720.

Process 1000 begins at processing block 1010, where ink deposition data 701 (e.g., ID1 and ID2) is received. At processing block 1020, current printer transfer functions (e.g., T0) is received (e.g., received from print controller 140). At processing block 1030, updated printer transfer functions (e.g., T1) is generated based on the ink deposition data 701 and the current printer transfer functions. Process 1000 may be repeated with input data corresponding to each color plane of printing system 130 to generate corresponding updated printer transfer functions.

As stated above, it is known from printer ink models that maintaining a constant ink deposition also achieves a constant OD. Accordingly, halftone designs (e.g., halftone threshold arrays) may be updated to form calibrated halftone designs to maintain ink deposition at a constant level (e.g., to maintain a level of a second ink deposition function with an updated halftone design applied that is the equivalent level to a first ink deposition function with an initial halftone design applied). As mentioned above, printer calibration logic 720 may also generate halftone calibration data. Accordingly, halftone generation logic 830 may be implemented to generate calibrated printer halftone threshold arrays for each color plane. In one embodiment, calibrated printer halftone threshold arrays are generated by modifying the thresholds of a threshold array (e.g., TA1 or a first halftone threshold array) associated with the halftoning of each pel forming element 165 column for all drop sizes.

Inverse transfer function generation engine 820 generates inverse transfer functions that are used to generate the updated printer halftone threshold arrays. According to one embodiment, the inverse transfer functions are used (e.g., by printer calibration logic 720) to transform thresholds of the current or first printer halftone threshold arrays to generate an updated printer halftone threshold array (e.g., TA2 or a second halftone threshold array). An inverse transfer function is the reversed (e.g., inverted) application of the transfer function, where the output digital count values of the transfer function form the input digital count values of the inverse transfer function and the input digital count values of the transfer function form the output digital count values of the inverse transfer function. The inverse transfer functions may be generated directly or from transfer functions by computing the mathematical inverse function of the transfer function. In one embodiment, inverse transfer functions may be received. Inverse transfer functions may be used for calibrating printing system 130 with a resulting technical benefit of providing a compact form with reduced computational requirements.

According to one embodiment, ink deposition data generated during first and second halftone calibration processes may be represented as:

$$ID 3 ( D C ) = [ {Z}^{0} {v}^{0} ] and ID 4 ( D C ) = [ {Z}^{0} {v}^{1} ] ,$$

where ID3 (e.g., a first ink deposition data) is the continuous function representation of the ink deposition function using the drop size set v0 scaled to use DC levels associated with a first halftone design (e.g., first halftone threshold array) and ID4 (e.g., a second ink deposition data) is the continuous function representation of the ink deposition function using drop size set v1 scaled to use DC levels associated with the first halftone design (e.g., the first halftone threshold array).

According to one embodiment, an inverse transfer function ITF3 is generated to obtain ID3 ink volume per pel, as represented by:

$$ID 3 ( D C ) = ID 4 ( TF 3 ( D C ) ) ;$$

$$TF 3 ( D C ) = ID {4}^{- 1} ( ID 3 ( D C ) ) ) ; and$$

$$ITF 3 ( D C ) = ID {3}^{- 1} ( ID 4 ( D C ) )$$

Subsequently, an updated halftone design (e.g., second halftone design, TA2 or second halftone threshold array) is generated having drop size change compensation TA2=ITF(TA1) for all drop sizes using TA1 halftone thresholds. Thus, TA2 is generated by using ITF3 (e.g., a printer transfer function or first printer transfer function) to transform each of the thresholds in the TA1 halftone for all drop sizes to obtain a set of corresponding thresholds that provide drop size change compensation with halftone thresholds.

Similarly, an updated halftone threshold array TA2 may be generated for each color plane of printing system 130 based on input data corresponding to the color plane. In this embodiment transformation by ITF3 function (e.g., an inverse printer transfer function) corrects the halftone threshold array to compensate for the drop size changes. Printer transfer functions including composite transfer functions may still be employed in this embodiment in addition to the halftone drop size change compensation to calibrate the printer for different substrates. Thus, providing a constant level of ink deposition to the substrate through compensation for drop size changes.

In an additional embodiment, the inverse of the updated printer transfer function may be used to obtain an updated threshold array printer system having an updated calibrated halftone to achieve drop size compensation when printing on a reference substrate. Where the reference substrate is a single paper substrate used for printing for calibration purposes. The halftone threshold transformation to generate TA2 in this case (e.g., compensation for v1 drop size set) is the inverse of the transfer function T1. The initial halftone threshold transformation to generate TA1 in this case (e.g., compensation for v0 drop size set) is the inverse of the transfer function T0.

In a further embodiment the inverse of the updated printer transfer function may be used to obtain an updated threshold array having an updated calibrated halftone to achieve the drop size compensation on a reference paper and customer substrate. The halftone threshold transformation to generate TA2 in this case (e.g., compensation for v1 drop size set) is the inverse of transfer function T1(substrateTF(DC)). The initial halftone threshold transformation to generate TA1 in this case (e.g., compensation for v0 drop size set) is the inverse of transfer function T0(substrateTF(DC)).

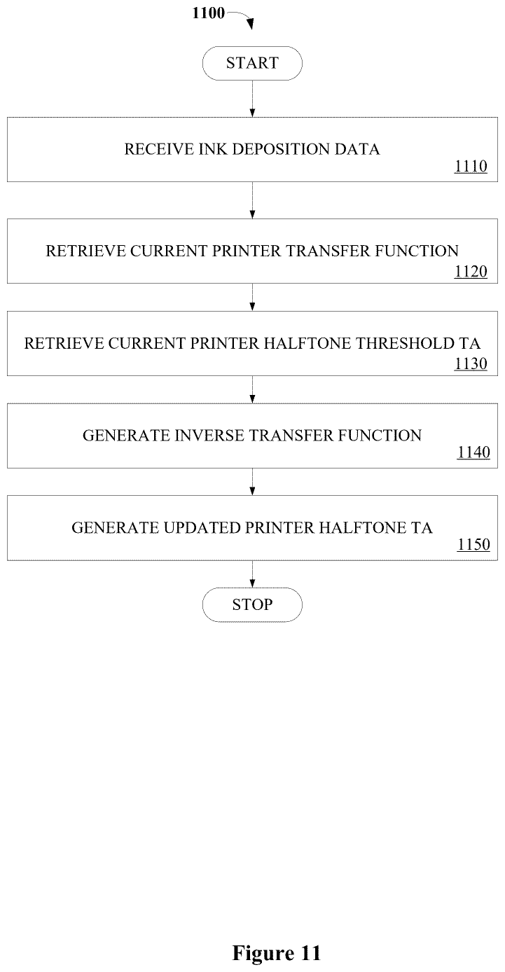

FIG. 11 is a flow diagram illustrating one embodiment of a process 1100 for generating an updated printer halftone threshold array based on the inverse of the printer transfer function T1. Process 1100 may be performed by processing logic that may include hardware (e.g., circuitry, dedicated logic, programmable logic, microcode, etc.), software such as instructions run on a processing device, or a combination thereof. In one embodiment, process 1100 is performed by printer calibration logic 720.

Process 1100 begins at processing block 1110, where ink deposition data 701 is received. At processing block 1120, current printer transfer functions (e.g., T0) is received. At processing block 1130, a current printer threshold array (e.g., TA1) is retrieved (e.g., retrieved from print controller 140). At processing block 1140, inverse transfer functions (e.g., ITF of T1) are generated based on the ink deposition data 701 and current printer transfer functions. At processing block 1150, an updated printer halftone threshold array (e.g., TA2) is generated by modifying thresholds of the current printer threshold array using the generated inverse transfer functions. Process 1100 may be repeated with input data corresponding to each color plane of printing system 130 to generate corresponding updated printer threshold arrays.

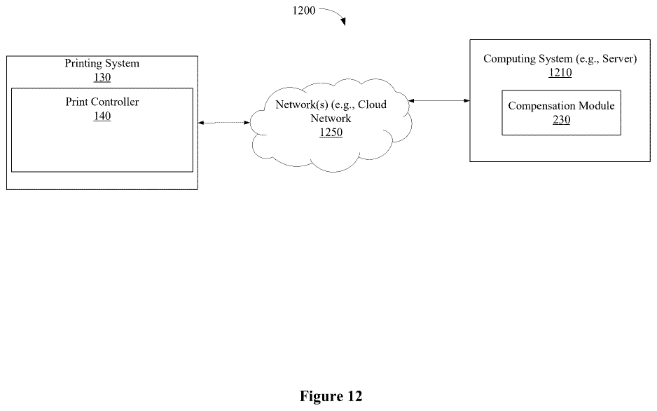

Although shown as a component of print controller 140, other embodiments may feature compensation module 230 included within an independent device communicably coupled to print controller 140. For instance, FIG. 12 illustrates one embodiment of compensation module 230 implemented in a network 1200. As shown in FIG. 12, compensation module 230 is included within a computing system 1210 and communicates with printing system 130 via a cloud network 1250.

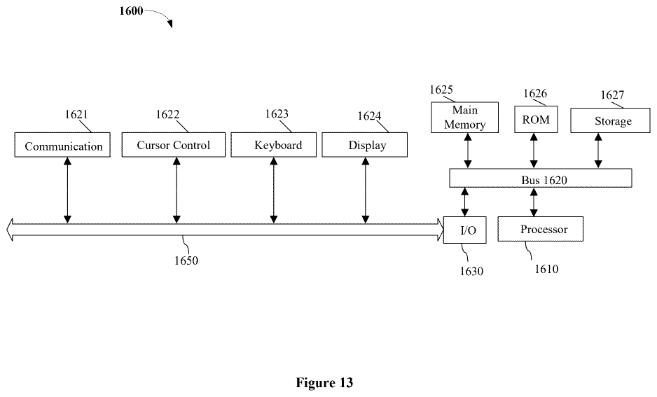

FIG. 13 illustrates a computer system 1600 on which printing system 130, print controller 140 and compensation module 230 may be implemented. Computer system 1600 includes a system bus 1620 for communicating information, and a processor 1610 coupled to bus 1620 for processing information.

Computer system 1600 further comprises a random-access memory (RAM) or other dynamic storage device 1625 (referred to herein as main memory), coupled to bus 1620 for storing information and instructions to be executed by processor 1610. Main memory 1625 also may be used for storing temporary variables or other intermediate information during execution of instructions by processor 1610. Computer system 1600 also may include a read only memory (ROM) and/or other static storage device 1626 coupled to bus 1620 for storing static information and instructions used by processor 1610.

A data storage device 1627 such as a magnetic disk or optical disc and its corresponding drive may also be coupled to computer system 1600 for storing information and instructions. Computer system 1600 can also be coupled to a second I/O bus 1650 via an I/O interface 1630. A plurality of I/O devices may be coupled to I/O bus 1650, including a display device 1624, an input device (e.g., an alphanumeric input device 1623 and or a cursor control device 1622). The communication device 1621 is for accessing other computers (servers or clients). The communication device 1621 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes a system comprising at least one physical memory device to store calibration logic and one or more processors coupled with the at least one physical memory device to execute the calibration logic to generate a second printer transfer function to calibrate ink deposition of a print system for each of the plurality of color planes based on first ink deposition data, second ink deposition data and a first printer transfer function, wherein the first ink deposition data, the second ink deposition data and the first printer transfer function are associated with a common halftone design.

Example 2 includes the subject matter of Example 1, wherein the second printer transfer function is generated to maintain a level of the second ink deposition data at an equivalent level to the first ink deposition data.

Example 3 includes the subject matter of Examples 1 and 2, wherein a transfer function transforms an input digital count to an output digital count and ink deposition data represents an output ink amount versus input digital count.

Example 4 includes the subject matter of Examples 1-3, wherein the calibration logic further to generate the first ink deposition data for each of a plurality of color planes based on first ink drop size data and ink drop fractions data and generate the second ink deposition data for each of the plurality of color planes based on second ink drop size data and the ink drop fractions data.

Example 5 includes the subject matter of Examples 1-4, wherein the first ink drop size data and the second ink drop size data are associated with the common halftone design.

Example 6 includes the subject matter of Examples 1-5, wherein the calibration logic further receives the ink drop fractions data, receives the first ink drop size data and receives the second ink drop size data.

Example 7 includes the subject matter of Examples 1-6, wherein the ink drop fractions data indicates a percentage of drops at each of a plurality of drop sizes at each digital count.

Example 8 includes the subject matter of Examples 1-7, wherein a transfer function comprises a lookup table.

Example 9 includes the subject matter of Examples 1-8, wherein the physical memory device further to store transfer function application logic and the one or more processors execute the transfer function application logic to apply the transfer function to a received contone image data prior to halftoning.

Example 10 includes the subject matter of Examples 1-9, further comprising a printer to apply halftoned image data to a print medium.

Example 11 includes the subject matter of Examples 1-10, wherein the calibration logic further receives the first ink drop size data and the second ink drop size data from the printer.

Some embodiments pertain to Example 12 that includes at least one computer readable medium having instructions stored thereon, which when executed by one or more processors, cause the processors to generate a second printer transfer function to calibrate ink deposition of a print system for each of the plurality of color planes based on first ink deposition data, second ink deposition data and a first printer transfer function; wherein the first ink deposition data, the second ink deposition data and the first printer transfer function are associated with a common halftone design.

Example 13 includes the subject matter of Example 12, wherein the second printer transfer function is generated to maintain a level of the second ink deposition data at an equivalent level to the first ink deposition data.

Example 14 includes the subject matter of Examples 12 and 13, having instructions stored thereon, which when executed by one or more processors, further cause the processors to generate the first ink deposition data for each of a plurality of color planes based on first ink drop size data and ink drop fractions data and generate the second ink deposition data for each of the plurality of color planes based on second ink drop size data and the ink drop fractions data.

Example 15 includes the subject matter of Examples 12-14, wherein the first ink drop size data and the second ink drop size data are associated with the common halftone design.

Example 16 includes the subject matter of Examples 12-15, having instructions stored thereon, which when executed by one or more processors, further cause the processors to receive the ink drop fractions data, receive the first ink drop size data, and receive the second ink drop size data.

Some embodiments pertain to Example 17 that includes a method comprising generating a second printer transfer function to calibrate ink deposition of a print system for each of the plurality of color planes based on first ink deposition data, second ink deposition data and a first printer transfer function; wherein the first ink deposition data, the second ink deposition data and the first printer transfer function are associated with a common halftone design.

Example 18 includes the subject matter of Example 17, wherein the second printer transfer function is generated to maintain a level of the second ink deposition data at an equivalent level to the first ink deposition data.

Example 19 includes the subject matter of Examples 17 and 18, further comprising generating the first ink deposition data for each of a plurality of color planes based on first ink drop size data and ink drop fractions data and generating the second ink deposition data for each of the plurality of color planes based on second ink drop size data and the ink drop fractions data.

Example 20 includes the subject matter of Examples 17-19, wherein the first ink drop size data and the second ink drop size data are associated with the common halftone design.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A system comprising:
at least one physical memory device to store calibration logic; and
one or more processors coupled with the at least one physical memory device to execute the calibration logic to generate a second printer transfer function to calibrate ink deposition of a print system for each of the plurality of color planes based on first ink deposition data, second ink deposition data and a first printer transfer function; wherein the first ink deposition data, the second ink deposition data and the first printer transfer function are associated with a common halftone design.

2. The system of claim 1, wherein the second printer transfer function is generated to maintain a level of the second ink deposition data at an equivalent level to the first ink deposition data.

3. The system of claim 1, wherein a transfer function transforms an input digital count to an output digital count and ink deposition data represents an output ink amount versus input digital count.

4. The system of claim 1, wherein the calibration logic further to:
generate the first ink deposition data for each of a plurality of color planes based on first ink drop size data and ink drop fractions data; and
generate the second ink deposition data for each of the plurality of color planes based on second ink drop size data and the ink drop fractions data.

5. The system of claim 4, wherein the first ink drop size data and the second ink drop size data are associated with the common halftone design.

6. The system of claim 5, wherein the calibration logic further:
receives the ink drop fractions data;
receives the first ink drop size data; and
receives the second ink drop size data.

7. The system of claim 1, wherein the ink drop fractions data indicates a percentage of drops at each of a plurality of drop sizes at each digital count.

8. The system of claim 1, wherein a transfer function comprises a lookup table.

9. The system of claim 1, wherein the physical memory device further to store transfer function application logic and the one or more processors execute the transfer function application logic to apply the transfer function to a received contone image data prior to halftoning.

10. The system of claim 9, further comprising a printer to apply halftoned image data to a print medium.

11. The system of claim 10, wherein the calibration logic further receives the first ink drop size data and the second ink drop size data from the printer.

12. At least one computer readable medium having instructions stored thereon, which when executed by one or more processors, cause the processors to generate a second printer transfer function to calibrate ink deposition of a print system for each of the plurality of color planes based on first ink deposition data, second ink deposition data and a first printer transfer function; wherein the first ink deposition data, the second ink deposition data and the first printer transfer function are associated with a common halftone design.

13. The computer readable medium of claim 12, wherein the second printer transfer function is generated to maintain a level of the second ink deposition data at an equivalent level to the first ink deposition data.

14. The computer readable medium of claim 12, having instructions stored thereon, which when executed by one or more processors, further cause the processors to:
generate the first ink deposition data for each of a plurality of color planes based on first ink drop size data and ink drop fractions data; and
generate the second ink deposition data for each of the plurality of color planes based on second ink drop size data and the ink drop fractions data.

15. The computer readable medium of claim 14, wherein the first ink drop size data and the second ink drop size data are associated with the common halftone design.

16. The computer readable medium of claim 15, having instructions stored thereon, which when executed by one or more processors, further cause the processors to:
receive the ink drop fractions data;
receive the first ink drop size data; and
receive the second ink drop size data.

17. A method comprising generating a second printer transfer function to calibrate ink deposition of a print system for each of the plurality of color planes based on first ink deposition data, second ink deposition data and a first printer transfer function; wherein the first ink deposition data, the second ink deposition data and the first printer transfer function are associated with a common halftone design.

18. The method of claim 17, wherein the second printer transfer function is generated to maintain a level of the second ink deposition data at an equivalent level to the first ink deposition data.

19. The method of claim 17, further comprising:
generating the first ink deposition data for each of a plurality of color planes based on first ink drop size data and ink drop fractions data; and
generating the second ink deposition data for each of the plurality of color planes based on second ink drop size data and the ink drop fractions data.

20. The method of claim 19, wherein the first ink drop size data and the second ink drop size data are associated with the common halftone design.
